(19) United States
(12) Patent Application Publication
(10) Pub. No.: US 2006/0274722 A1
(43) Pub. Date: Dec. 7, 2006

(54) Metering dynamically provisioned resources

(75) Inventors: Michael George Polan, Markham (CA); William Pettit Horn, Scarsdale, NY (US)

Correspondence Address: Steven M. Greenberg, Esq.;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/143,056

(22) Filed: Jun. 2, 2005

(51) Int. Cl. H04L 12/66

(52) U.S. Cl. 370/352; 370/431; 709/226

(57) ABSTRACT

There is provided a method, system and apparatus for metering dynamically provisioned resources. A method for metering dynamically provisioned resources can include capturing or receiving captured resource usage data for dynamically provisioned resources, retrieving resource allocation data for the dynamically provisioned resources collected by a resource provisioning system, and correlating the captured resource usage data with the retrieved resource allocation data. In particular, the capturing step can include capturing or receiving captured resource allocation records from provisioning systems driven by associated service level managers.

### BACKGROUND OF THE INVENTION

1. Statement of the Technical Field

The present invention relates to the field of distributed and on-demand computing, and more particularly to application metering in a distributed and on-demand computing environment.

2. Description of the Related Art

Among the many challenges faced by those who manage the capacity and performance of an enterprise system is the characterization of resource consumption by a particular application or workload. The continuing movement towards distributed systems has complicated this activity as there are several methods for collecting transaction data on a single system. For instance, a transaction processing monitor can be configured to capture some form of resource consumption data. Similarly, some database management systems provide facilities for capturing transaction activity within the context of each access request.

Facilities within a particular operating system also may have a built-in notion of what a transaction is and will store or report information related to that transaction. Furthermore, application developers can imbed instrumentation within application code in order to obtain application specific transaction data. Finally, application profilers for a particular operating environment can gather large amounts of data characterizing the behavior of an application hosted within the operating environment. In all cases, however, when applied to the distributed environment, it can be difficult to track transaction-level resource consumption when several elements in a distributed environment contribute towards the completion of a transaction

Traditional resource metering records the usage of a resource and the attributes of the resource-consuming party. In a traditional computing environment, resources are assigned statically, or at fixed, known intervals by an operator. Accounting for usage in the ordinary circumstance, while tedious, was possible. In contrast, in an on-demand environment, on-demand service managers often allocate and remove resources as needed to support a given level of service.

In an on-demand computing environment, resources can be allocated from and returned to shared free pools. Specifically, the resources from the shared free pools can be assigned autonomically to the consuming services as needed to support a given level of service. As such, operators may not immediately become aware of the resource assignments. At best, it remains possible only to determine resource allocation by examining the logs maintained by the autonomic service level managers and provisioning systems.

Conventional resource metering approaches, however, have proven deficient when the consumption of resources must be determined at a finer granularity than resource assignment. For example, if the consumption of CPU cycles must be determined, understanding simply that a processor has been assigned to a consumer is not sufficient. CPU cycle consumption records themselves are also insufficient, as the owner of the CPU resource may not be clearly identified by the CPU cycle consumption records.

### SUMMARY OF THE INVENTION

Embodiments of the present invention address the deficiencies of the art in respect to application metering and provide a novel and non-obvious method, system and apparatus for metering dynamically provisioned resources. A method for metering dynamically provisioned resources can include capturing resource usage data (or retrieving captured resource usage data) for dynamically provisioned resources, retrieving resource allocation data for the dynamically provisioned resources collected by a resource provisioning system, and correlating the captured resource usage data with the retrieved resource allocation data. In particular, the capturing step can include capturing resource allocation records (or retrieving captured resource allocation records) from provisioning systems driven by associated service level managers.

A system for metering dynamically provisioned resources can include a resource meter and consolidation logic coupled to the resource meter. The consolidation logic can be programmed to capture resource usage data (or retrieving captured resource usage data) for dynamically provisioned resources, to retrieve resource allocation data collected by a communicatively linked resource provisioning system, and correlate the captured resource usage data with the retrieved resource allocation data. The system further can include an accounting system configured to receive correlated captured resource usage data and retrieved resource allocation data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of a distributed system configured for metering dynamically provisioned resources in accordance with an embodiment of the present invention; and,

FIG. 2 is a flow chart illustrating a process for metering dynamically provisioned resources in the system of FIG. 1.

### DETAILED DESCRIPTION OF THE PREFERRED EMBODIMENTS

Embodiments of the present invention provide a method, system and apparatus for metering dynamically provisioned resources. In accordance with an embodiment of the present invention, resource metrics can be consolidated with resource provisioning records provided by a resource provisioning manager to produce a composite set of records of the consumption of resources of particular resource consumers. Specifically, the resource provisioning manager can store resource ownership data separately from the collection of resource usage data provided to a resource meter. A consolidation process can scan the resource ownership data to match the resource ownership data with the resource usage data to provide a consolidated, granular view of the resource metrics among dynamically provisioned resources.

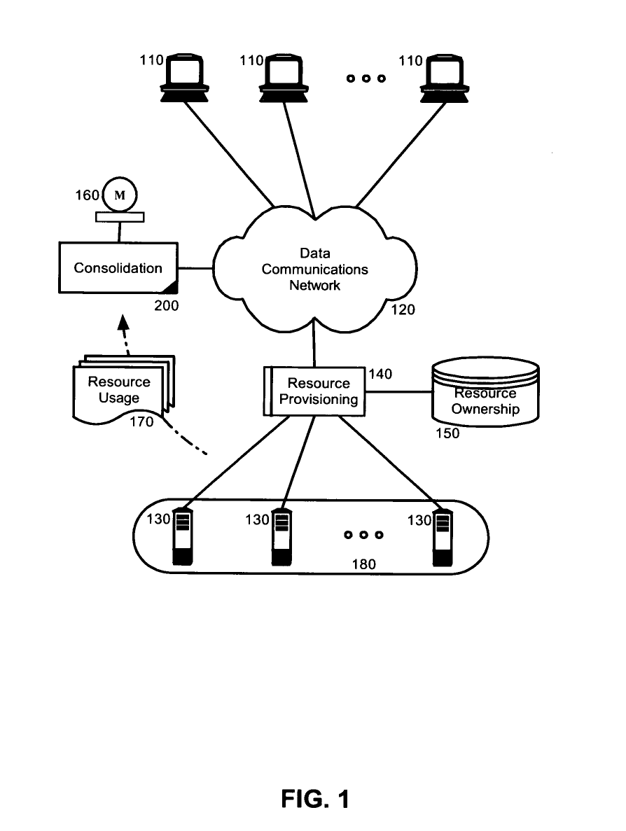

In further illustration, FIG. 1 is schematic illustration of a distributed system configured for metering dynamically provisioned resources. The distributed system can include one or more dynamically provisionable computing resources 130 managed by a resource provisioning manager 140. Provisionable computing resources 130 can include hardware computing systems such as application servers, and hardware computing elements such as CPU cycles, data storage, memory utilization or network throughput, or software computing elements such as access to discrete sets of computing logic.

One or more client computing processes 110 can be communicatively coupled to the resource provisioning manager 140 over a data communications network 120. In this regard, the client computing processes 110 can be arranged in a client-server fashion in respect to the provisionable computing resources 130, or the client computing processes 110 can be partially hosted within other servers (not shown). Notably, the distributed system can be an on-demand environment in which the dynamically provisionable resources 130 can be allocated and de-allocated on-demand as required by the client computing processes 110. Specifically, the provisionable computing resources 130 can be grouped together into a free pool 180 for use by the client computing processes 110. For example, the communicatively coupled client computing processes 110 can be Web applications requiring the use of Web application servers which can be viewed as the resources 130.

The resource provisioning manager 140 can determine when to allocate the resources 130 in the free pool 180 to requesting ones of the client computing processes 110. Consequently, the resource provisioning manager 140 can record the ownership of assigned ones of the dynamically provisionable resources 130 in a data store of resource ownership 150. By comparison, resource usage data 170 for the dynamically provisionable resources 130 can be collected separately from the resource ownership data 150.

In this regard, while the resource provisioning manager 140 can collect the resource ownership data 150, a resource meter 160 can collect the resource usage data 170. Importantly, however, consolidation logic 200 can receive the resource usage data 170 in addition to or on behalf of the resource meter 160. The consolidation logic 200 can access the resource ownership data 150 collected by the resource provisioning manager 140 and can match the resource ownership data 150 with the resource usage data 170 to provide a more granular view of resource usage for the dynamically provisionable resources 130.

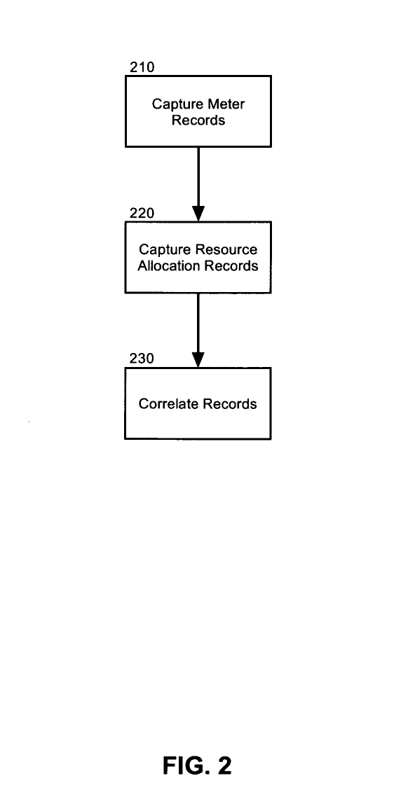

In more specific illustration, FIG. 2 is a flow chart illustrating a process for metering dynamically provisioned resources in the system of FIG. 1. Beginning in block 210, meter records indicating resource consumption can be captured from the dynamically provisioned resources and can be made available to a consolidation component. The meter records can be captured irrespective of the consumer of the resources. For example, the capture of the resource usage data can be performed conventionally, excepting that the recipient of the resource usage data can change.

In block 220, resource allocation records can be captured from the provisioning systems driven by the service level managers. The resource allocation records indicate when and to whom or what a given resource has been allocated from a free pool, or removed from the free pool. Thus, the resource allocation records from the provisioning system provide a chronological record of resource ownership. Subsequently, the resource allocation records can be passed on to the consolidation component. Finally, in block 230, the resource allocation records can be cross-referenced to the consumption records provided by the resource itself to correctly associate consumption of the resources by consumers at particular times during a desired time frame given that any one resource can have multiple consumers as the resource may have been repeatedly allocated from and returned to the free pool to and from different consumers at different times.

Optionally, the correctly associated resource consumption records can be passed to business support systems or operational support systems. A traditional accounting system for rating, cost allocation or billing is an example of a business support system, whereas a capacity planning system is an example of an operational support system. In the accounting system example, the sum of CPU cycles consumed for a given period by a given consumer might include: 1) all of the cycles reported as used on dedicated CPUs; and 2) the cycles reported as used on CPUs that were temporarily assigned during a period of peak traffic. The sum will not include those cycles consumed by another consumer during periods where the temporary CPUs were re-allocated to that other consumer. Similarly, in the capacity planning system example, future consumer-specific CPU requirements can be inferred from consumption trends established by the observing consumer-specific CPU consumption.

Embodiments of the present invention can be realized in hardware, software, or a combination of hardware and software. An implementation of the method and system of the present invention can be realized in a centralized fashion in one computer system or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product on a computer usable medium, which comprises all the features enabling the implementation of the methods described herein, and which, when loaded in a computer system is able to carry out these methods.

It is important to note that while embodiments of the present invention have been described in the context of a fully functioning data processing system, those of ordinary skill in the art will appreciate that the processes of embodiments of the present invention are capable of being distributed in the form of a computer usable medium of instructions and a variety of forms and that embodiments of the present invention apply equally regardless of the particular type of signal bearing media actually used to carry out the distribution. Examples of computer usable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer usable media may take the form of coded formats that are decoded for actual use in a particular data processing system.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for metering dynamically provisioned resources comprising the steps of:
receiving captured resource usage data for dynamically provisioned resources;
retrieving resource allocation data for said dynamically provisioned resources collected by a resource provisioning system; and,
correlating said captured resource usage data with said retrieved resource allocation data.

2. The method of claim 1, wherein said receiving step comprises receiving captured resource allocation records from provisioning systems driven by associated service level managers.

3. The method of claim 1, further comprising the step of forwarding said correlated captured resource usage data and retrieved resource allocation data to a business support system.

4. The method of claim 1, further comprising the step of forwarding said correlated captured resource usage data and retrieved resource allocation data to an operational support system.

5. The method of claim 1, wherein said dynamically provisioned resources comprise hardware resources.

6. The method of claim 1, wherein said dynamically provisioned resources comprises application logic resources.

7. The method of claim 1, wherein said resource allocation records retrieved from said provisioning system indicate when and to whom a given resource has been allocated and removed.

8. A data processing system for metering dynamically provisioned resources, the data processing system comprising:
a resource meter;
a free pool of provisionable resources; and,
consolidation logic coupled to said resource meter and programmed to receive captured resource usage data for dynamically provisionable resources in said free pool, to retrieve resource allocation data collected by a communicatively linked resource provisioning system, and correlate said captured resource usage data with said retrieved resource allocation data.

9. The system of claim 8, wherein said provisioning system is driven by associated service level managers.

10. The system of claim 8, further comprising a business support system configured to receive correlated captured resource usage data and retrieved resource allocation data.

11. The system of claim 8, further comprising a operational support system configured to receive correlated captured resource usage data and retrieved resource allocation data.

12. The system of claim 8, wherein said dynamically provisioned resources are resources selected from the group consisting of hardware resources, application logic resources, and specific instance of application logic resources.

13. The system of claim 8, wherein said dynamically provisioned resources comprises application servers.

14. The system of claim 8, wherein said resource allocation records retrieved from said provisioning system indicate when and to whom a given resource has been allocated or removed.

15. A machine usable medium having stored thereon a computer program for metering dynamically provisioned resources, the computer program comprising a routine set of instructions which when executed by a machine causes the machine to perform the steps of:
receiving captured resource usage data for dynamically provisioned resources;
retrieving resource allocation data for said dynamically provisioned resources collected by a resource provisioning system; and,
correlating said captured resource usage data with said retrieved resource allocation data.

16. The machine usable medium of claim 15, wherein said receiving step comprises receiving captured resource allocation records from provisioning systems driven by associated service level managers.

17. The machine usable medium of claim 15, further comprising an additional set of instructions which when executed by the machine causes the machine to further perform the step of forwarding said correlated captured resource usage data and retrieved resource allocation data to an accounting system.

18. The machine usable medium of claim 15, further comprising an additional set of instructions which when executed by the machine causes the machine to further perform the step of forwarding said correlated captured resource usage data and retrieved resource allocation data to an operational support system.

19. The machine usable medium of claim 15, wherein said dynamically provisioned resources are resources selected from the group consisting of hardware resources, application logic resources, and specific instances of application logic resources.

20. The machine usable medium of claim 15, wherein said resource allocation records retrieved from said provisioning system indicate when and to whom a given resource has been allocated or removed.
